(19) United States
(12) Patent Application Publication
(10) Pub. No.: US 2015/0063079 A1
(43) Pub. Date: Mar. 5, 2015

(54) ELECTRONIC DEVICE

(71) Applicant: Seiko Epson Corporation, Shinjuku-ku (JP)

(72) Inventors: Tadasuke Kotaki, Matsumoto-shi (JP); Reiko Sato, Azumino-shi (JP)

(21) Appl. No.: 14/473,522

(22) Filed: Aug. 29, 2014

(30) Foreign Application Priority Data
Sep. 2, 2013 (JP) 2013-181107

(51) Int. Cl. G04R 20/02; G04G 9/00

(52) U.S. Cl. CPC G04R 20/02; G04G 9/0064
USPC 368/47

(57) ABSTRACT

A running watch includes: a GPS signal reception portion which captures a satellite signal transmitted from a GPS satellite and processes the captured satellite signal; a chronograph process portion which measures a lapse of time; a display portion which displays a screen; an operation button which indicates an operation; and a control portion which displays a first screen showing a capturing circumstance of the satellite signal on the display portion when the GPS signal reception portion initiates the capturing of the satellite signal, and which continues the capturing of the satellite signal with respect to the GPS signal reception portion and displays a second screen showing that a measurement can be initiated by the chronograph process portion on the display portion when a predetermined operation is indicated from the operation button.

### BACKGROUND

1. Technical Field

The present invention relates to an electronic device.

2. Related Art

In recent years, as JP-A-10-332414 shows, an apparatus which takes a measurement of a position based on a satellite signal transmitted by a radio wave from a satellite, by using a satellite positioning system which is represented by a global positioning system (GPS), and measures movement information of a moving object based on a time change of the measured position, is put to a practical use. In addition, there is also provided a watch which implements such a measuring function and a timing function, and has many functions that display various types of information while traveling based on the movement information and the timing information.

In a case where the satellite positioning system is used, in order to determine a satellite which can receive a satellite signal, orbital information, such as an almanac (astronomical calendar) or an ephemeris (broadcast ephemeris), is obtained from a navigation message or the like transmitted from the satellite. The almanac is calendar information which includes information which is related to an approximate position of an orbit of the satellite, and the ephemeris is calendar information which includes information which is related to a specific position of the orbit of the satellite.

The orbital information has an effective life span. For example, the effective life span of the ephemeris is an extent of several hours, and the effective life span of the almanac is an extent of several days. An apparatus which uses the satellite positioning system is required to obtain and maintain effective orbital information in order to acquire precise positional information. Therefore, when the orbital information is not effective, the apparatus is required to obtain initial effective orbital information, to capture the satellite signal from the satellite based on the orbital information, and to obtain positional information from the captured satellite signal.

However, in the apparatus in the related art, while a target satellite to be captured is determined and the satellite signal is captured from the determined satellite, it is not possible to perform other processes, even in a process which does not use the positional information, such as a timing process, in parallel. Therefore, it is required to wait for the capturing of the satellite signal to be completed, and to initiate the timing process.

### SUMMARY

An advantage of some aspects of the invention is to perform a timing process even during performing a capturing process of a satellite signal, in parallel.

The invention can be implemented as the following forms or application examples.

### Application Example 1

This application example is directed to an electronic device including: a reception process portion which captures a satellite signal transmitted from a positioning satellite and processes the satellite signal; a measurement process portion which measures a lapse of time; a display portion which displays a screen; an indication portion which indicates an operation; and a control portion which displays a first screen showing a capturing circumstance of the satellite signal on the display portion when the reception process portion initiates the capturing of the satellite signal, and which continues the capturing of the satellite signal with respect to the reception process portion and displays a second screen showing that a measurement can be initiated by the measurement process portion on the display portion when a predetermined operation is indicated from the indication portion.

According to this configuration, in a state where the first screen showing the capturing circumstance of the satellite signal is displayed on the display portion, when the predetermined operation from the indication portion is indicated, the reception process portion continues the capturing of the satellite signal, and the second screen showing that the measurement can be initiated by the measurement process portion is displayed on the display portion. Therefore, even during the capturing of the satellite signal, since the second screen showing that the measurement can be initiated is displayed, it is possible to perform the capturing process of the satellite signal and the measurement process by the measurement process portion, in parallel.

### Application Example 2

In the electronic device according to the application example described above, it is preferable that at least one of an image of the positioning satellite corresponding to the capturing circumstance and a guidance image for indicating the predetermined operation by the indication portion is displayed on the first screen.

According to this configuration, since the capturing circumstance of the satellite signal is displayed by the image of the positioning satellite, it is possible to visually recognize the capturing circumstance. In addition, it is also possible to easily perform the indication in accordance with the guidance image to transit to the second screen.

### Application Example 3

In the electronic device according to the application example described above, it is preferable that, on the first screen, the image of the positioning satellite corresponding to the capturing circumstance and the guidance image for indicating the predetermined operation by the indication portion are displayed at the same time.

According to this configuration, as the capturing circumstance of the satellite signal is displayed as the image of the positioning satellite and the guidance image on the display portion at the same time, it is possible to make a user operation for displaying the guidance image to transit to the second screen on the display portion unnecessary, and to improve usability.

### Application Example 4

In the electronic device according to the application example described above, it is preferable that, on the second screen, at least one of temporal information which is necessary in moving based on the measurement of the measurement process portion and movement information calculated based on the satellite signal is displayed.

### Application Example 5

In the electronic device according to the application example described above, it is preferable that an acceleration detection portion which detects acceleration and calculates a movement amount based on the detected acceleration is provided, and the control portion calculates the movement information based on the movement amount calculated by the acceleration detection portion when the capturing of the satellite signal is not completed.

According to this configuration, even when the capturing of the satellite signal is not completed, it is possible to calculate the movement information, such as movement distance, which considers an initiation of the measurement by the measurement process portion as a starting point based on the movement amount calculated by the acceleration detection portion.

### Application Example 6

In the electronic device according to the application example described above, it is preferable that the reception process portion obtains orbital information showing a position on an orbit of the positioning satellite, and determines the positioning satellite based on the obtained orbital information.

### BRIEF DESCRIPTION OF THE DRAWINGS

The invention will be described with reference to the accompanying drawings, wherein like numbers reference like elements.

FIG. 1 is a schematic view illustrating an outline of a GPS system.

FIG. 2 is a block diagram illustrating a functional configuration of a running watch according to an embodiment of the invention.

FIG. 3 is a flow chart illustrating a flow of a process in the running watch according to the embodiment of the invention.

FIGS. 4A to 4E are views illustrating transition of display screens.

### DESCRIPTION OF EXEMPLARY EMBODIMENTS

Hereinafter, an embodiment of the invention will be described with reference to the drawings.

### Embodiment

Hereinafter, an appropriate example of an electronic device according to the invention will be described. Here, an outline of a running watch 10 which is an electronic device that receives and uses a signal for positioning or the like by a radio wave from a positional information satellite or the like that constitutes a communication system, will be described as an example. In the embodiment, a GPS system is assumed as the communication system. However, the embodiment is not limited thereto, and various satellite positioning systems can be assumed.

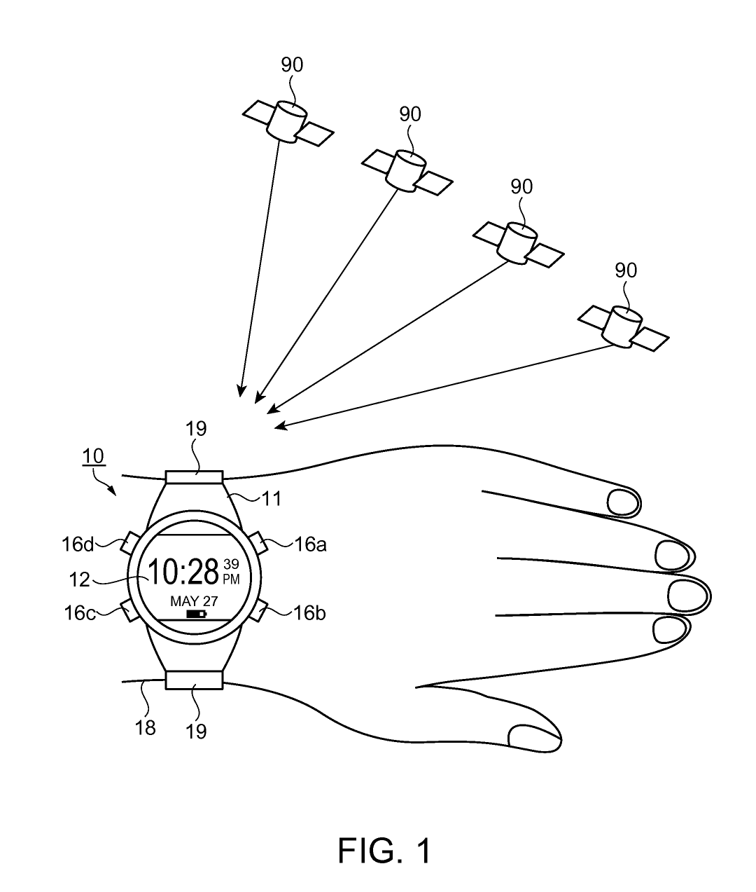

FIG. 1 is a schematic view illustrating an outline of a GPS system. As illustrated in FIG. 1, a GPS satellite 90, which is a positioning satellite, is a positional information satellite that orbits on a predetermined orbit above the Earth, and transmits a satellite signal which superposes a navigation message or the like to a microwave of 1.57542 GHz, for example, to the ground by the radio wave. The GPS satellite 90 has an atomic timepiece mounted thereon, and includes GPS time information which is extremely accurate time information that is timed by the atomic timepiece in the satellite signal. For this reason, the running watch 10 which is provided with a function as a GPS receiver can receive the satellite signal and display an accurate time by correcting a progress or a delay of an internal time.

In addition, the satellite signal includes orbital information which shows a position on the orbit of the GPS satellite 90. In other words, the running watch 10 can perform a positioning computation. In general, by receiving the satellite signal transmitted from each of a plurality of GPS satellites 90, the running watch includes a function that performs the positioning computation by using the orbital information and the GPS time information which are included in the received satellite signal. Furthermore, in the embodiment, an aspect in which the satellite signal is received from four GPS satellites 90 will be described.

By performing the positioning computation, the running watch 10 can easily correct the time by matching a current position, or the like. Furthermore, if the satellite signal is used, various applications, such as displaying a current position, taking a measurement of a movement distance, or taking a measurement of a movement speed, are possible. In the running watch 10, the information can be displayed in a digital manner by a liquid crystal panel 12.

In the embodiment, the running watch 10 includes an exterior case 11 and a belt 19 for installing the exterior case 11 to an arm 18. On a side surface of the exterior case 11, operation buttons 16 (16a, 16b, 16c, and 16d) are provided. The operation buttons 16 function as an indication portion, and indicate selection of a measurement mode, an initiation of the measurement, a temporary stop of the measurement, and a completion of the measurement with respect to a process portion 30, as the user pushes the operation button.

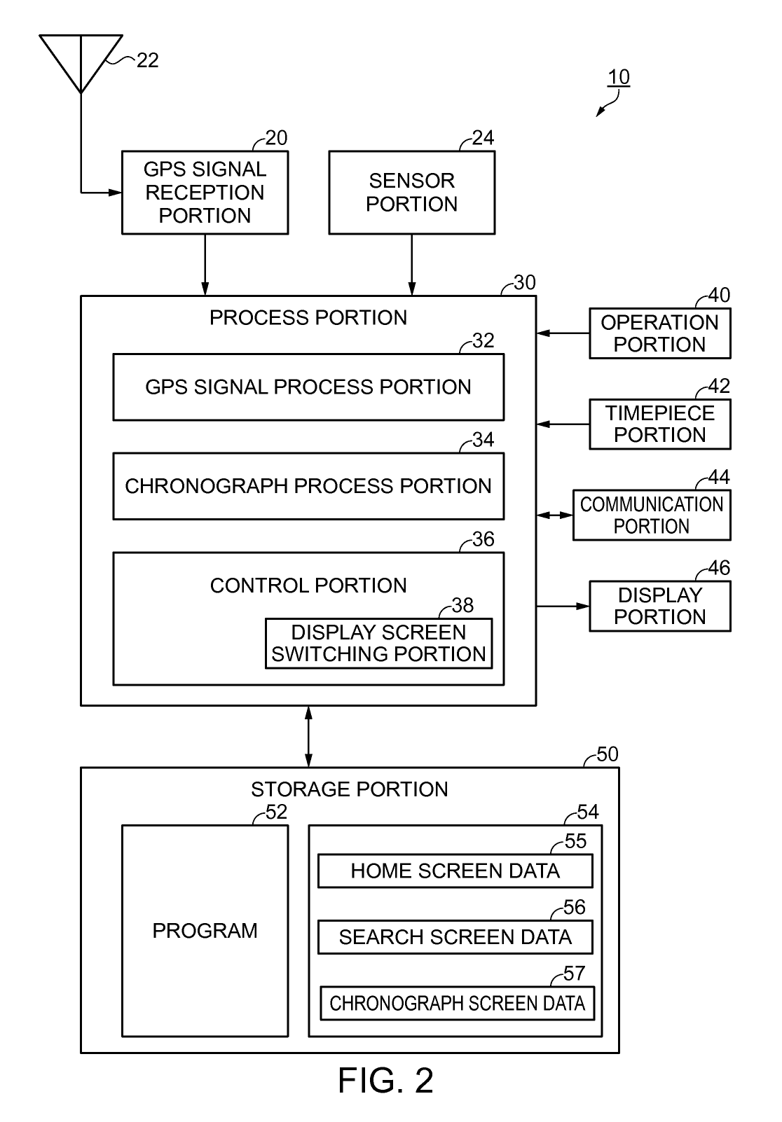

FIG. 2 is a block diagram illustrating an example of a functional configuration of the running watch 10. The running watch 10 includes a GPS antenna 22, a GPS signal reception portion 20, a sensor portion 24, the process portion 30, an operation portion 40, a timepiece portion 42, a communication portion 44, a display portion 46, and a storage portion 50.

The GPS signal reception portion 20 determines the GPS satellite 90 of which the satellite signal is a target to be captured, is a module which obtains the satellite signal transmitted by the determined GPS satellite 90, and corresponds to a reception process portion.

The GPS signal reception portion 20 determines the GPS satellite 90 which performs the capturing based on the orbital information, such as an almanac or an ephemeris that can be obtained from the satellite signal. In the embodiment, the GPS signal reception portion 20 obtains and maintains the almanac or the ephemeris, and uses the maintained almanac or ephemeris when a life span thereof is effective.

After obtaining an approximate position of the GPS satellite 90 based on the almanac, the GPS signal reception portion 20 obtains a specific position of the GPS satellite 90 based on the ephemeris, determines four GPS satellites 90 which are the targets to be received based on the obtained positional information, and receives radio wave signals, that is, radio frequency (RF) signals, transmitted from each of the determined GPS satellites 90 by the GPS antenna 22. Furthermore, since frequency of the RF signal transits by a Doppler effect in accordance with the GPS satellite 90 and a movement of the device itself, the GPS signal reception portion 20 can capture the RF signal considering the transition of the frequency.

After a predetermined signal process is performed and digitalized, the captured RF signal is output as the satellite signal in which a code phase is determined and captured.

Furthermore, a time, which is necessary from the determining of the GPS satellite 90 which is the target to be captured to the capturing of the satellite signal transmitted from the determined GPS satellite 90, is largely changed according to whether the almanac or the ephemeris is effective or not. For example, if both of the maintained almanac and the ephemeris are effective (hot start), the process until the output of the satellite signal is completed in 10 or less seconds. However, if both of the maintained almanac and the ephemeris are not effective, and in a case where the process is initiated after the almanac is obtained (cold start), the process until the output of the satellite signal requires an extent of several minutes.

The sensor portion 24 has a function that detects acceleration, and is a sensor unit which is configured to have an inertial sensor that is an acceleration sensor or a gyro sensor, for example. Furthermore, the sensor portion 24 corresponds to an acceleration detection portion.

The operation portion 40 is an input apparatus which is configured to have the operation button 16 or the like, and outputs the signal showing that the buttons are pushed to the process portion 30.

The timepiece portion 42 is a timepiece inside the running watch 10, and is configured to have a crystal oscillator which is a quartz crystal resonator and an oscillation circuit. The time information of the timepiece portion 42 is output to the process portion 30 at any time.

The communication portion 44 is a communication apparatus for transmitting and receiving the information used in the apparatus between the outside information processing apparatuses according to control of the process portion 30. Examples of the communication technique of the communication portion 44 can include various methods, such as a wire connection method via a cable in conformity to a predetermined communication standard, a connection method via an intermediate apparatus which also serves as a charger referred to as a cradle, or a wireless connection method by using near-field wireless communication.

The display portion 46 is a display apparatus which is configured to have a liquid crystal display (LCD) as the liquid crystal panel 12, and displays various types of information based on the display signal output from the process portion 30.

The process portion 30 is a processor which generally controls each functional portion of the running watch 10 according to a program 52 stored in the storage portion 50, and is configured to have a processor, such as a central processing unit (CPU) or a digital signal processor (DSP).

In the embodiment, the process portion 30 includes a GPS signal process portion 32, a chronograph process portion 34, and a control portion 36, as main functional portions.

The GPS signal process portion 32 obtains the satellite signal output by the GPS signal reception portion 20, and arithmetically operates and obtains measurement information by analyzing the obtained satellite signal. The measurement information includes an amount that is referred to as a code phase or a Doppler frequency that captures the satellite signal, or an amount that is referred to as a pseudo range or a pseudo range rate between the running watch 10 and the GPS satellite 90.

By using the measurement information, the GPS signal process portion 32 performs computation of a known position and computation of movement speed vector for every four GPS satellites 90, and calculates the positional information of the device itself based on the pseudo range between the four GPS satellites 90.

Furthermore, the GPS signal process portion 32 calculates the movement distance or the movement speed which considers a reference position where the measurement is initiated as a starting point based on the calculated positional information of the device itself. In the embodiment, the running watch 10 is configured to be able to selectively set the reception of the satellite signal.

The chronograph process portion 34 measures an elapsed time based on the time information output from the timepiece portion 42, and calculates temporal information, such as a lap time or a split time, based on the measured elapsed time. Furthermore, the chronograph process portion 34 corresponds to a measurement process portion.

The control portion 36 has a function that controls operations of each functional portion, such as the GPS signal reception portion 20, the GPS signal process portion 32, and the chronograph process portion 34, or a function that generates a display screen for displaying each of process results and displays the display screen on the display portion 46.

In the embodiment, corresponding to a process circumstance of each functional portion, the control portion 36 transits to any one of a satellite capture display mode which displays a display screen (search screen) showing a capturing state of the satellite signal, a time display mode which displays a display screen (home screen) showing current time, and a chronograph display mode which displays a display screen (chronograph screen) showing the movement information, such as traveling time, traveling distance, or speed of the user, and displays the display screen corresponding to each of the modes. Furthermore, the search screen corresponds to a first screen, and the chronograph screen corresponds to a second screen.

In addition, the control portion 36 includes a display screen switching portion 38 which switches the display screen displayed on the display portion 46. Based on the indication of the operation portion 40, in a state where the process of the functional portion which is currently in operation is continued, the display screen switching portion 38 changes the display screen of the display mode which is currently transiting, and includes a function that displays the display screen of another display mode on the display portion 46.

For example, in a state where the capturing process of the satellite signal is continued by the GPS signal reception portion 20, it is possible to change the screen to the search screen and display the chronograph screen, on the display portion 46. Furthermore, the chronograph screen displays various measurement operations to be indicatable. When the user indicates a desired operation, the control portion 36 performs the capturing process and a process of the indicated operation, in parallel.

Furthermore, when a measurement of the movement distance is indicated while the GPS signal reception portion 20 performs the capturing process of the satellite signal, the process portion 30 may calculate a movement amount based on an output signal of the inertial sensor of the sensor portion 24 in place of the calculation of the positional information by the GPS signal process portion 32, and derive the movement distance based on the calculated movement amount.

The storage portion 50 is configured to have a storage apparatus, such as a read only memory (ROM), a flash ROM, or a random access memory (RAM), and stores a program 52 for controlling the running watch 10 by the process portion 30 or data 54 for performing various application processes. Furthermore, the data 54 includes home screen data 55 for displaying the home screen, search screen data 56 for displaying the search screen, and chronograph screen data 57 for displaying the chronograph screen.

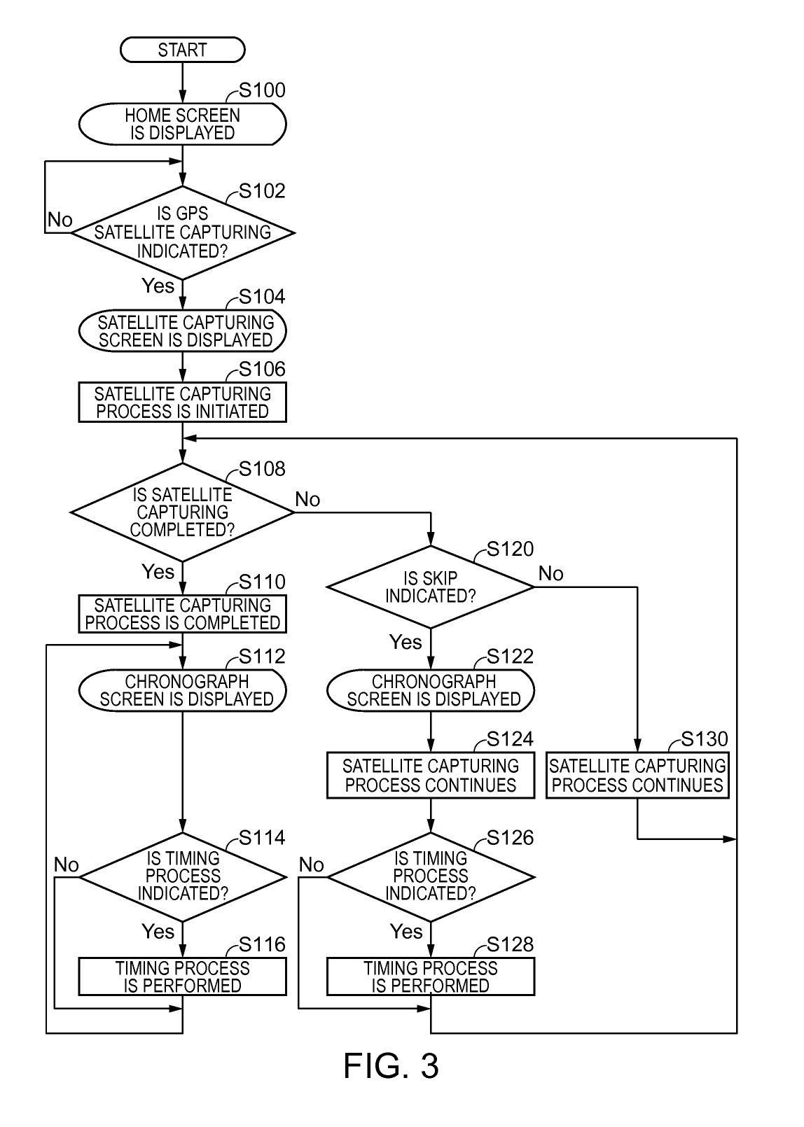

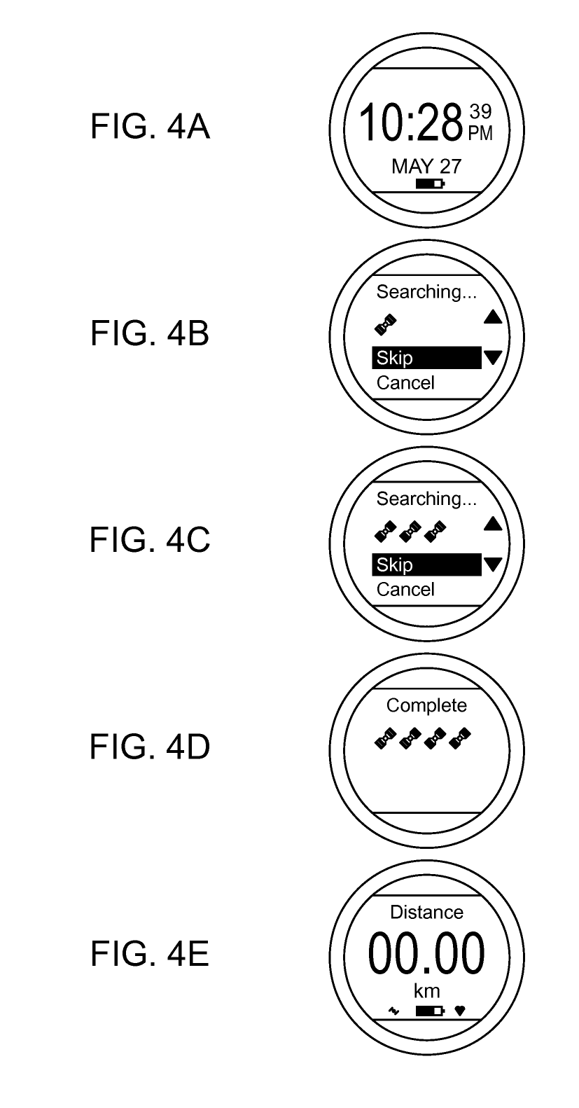

FIG. 3 is a flow chart illustrating a flow of a process in the running watch 10, and describes with appropriate reference to a view illustrating the transition of the display screen in FIGS. 4A to 4E. Furthermore, in the following description, the control portion 36 is described to be limited to an aspect in which only the movement distance is displayed on the chronograph screen.

When the running watch 10 is activated, the process portion 30 is at a home position, transits to a waiting state which is set not to receive the satellite signal. At the same time, the control portion 36 transits to a time display mode, and displays the current time on the display portion 46 as a home screen, as illustrated in FIG. 4A (Step S100).

Next, as the user sets the satellite signal to be received, the process portion 30 determines whether or not the GPS satellite capturing is indicated (Step S102), and repeats the determination of Step S102 when the GPS satellite capturing is not indicated (NO in Step S102).

In the embodiment, if a predetermined operation button 16 is pushed when the home screen is displayed, a selection screen (not illustrated) is displayed, and the GPS satellite capturing is indicated when the user selects a chronograph function from the selection screen. In this manner, when the GPS satellite capturing is indicated (YES in Step S102), the control portion 36 transits to the satellite capture display mode, and the search screen which shows the capturing state as illustrated in FIG. 4B is displayed on the display portion 46 (Step S104). The process portion 30 determines the GPS satellite 90 to be captured, and initiates the satellite capturing process that captures the satellite signal transmitted from the determined GPS satellite 90 (Step S106).

In the embodiment, the control portion 36 visually displays the capturing circumstance of the satellite signal for every GPS satellite 90 by the number of the satellites of the search screen. For example, FIG. 4B displays the capturing circumstance by the image of the GPS satellite 90, and shows one captured GPS satellite 90 among the four GPS satellites 90 to be captured for the positioning computation. In addition, FIG. 4C displays that three GPS satellites 90 are captured among the four GPS satellites 90 to be captured. By displaying visually in this manner, the user can roughly assume the time which is necessary until the end of the capturing.

Furthermore, the capturing circumstance is not limited to the display by the number of the satellites, and an aspect, in which a progress bar, a capturing ratio, or the number of capturing is displayed in numbers, can be considered.

In the embodiment, in addition to the capturing circumstance of the satellite signal for every GPS satellite 90 on the search screen, two options are displayed as a guidance image indicated by the operation button 16. One of the options is a “SKIP” option which corresponds to the predetermined operation and indicates to skip the satellite capture display mode and transit to a mode (chronograph display mode) that moves to the next mode. The other option is a “CANCEL” option which indicates to cancel the satellite capture display mode and transit to an initial time display mode. FIG. 4B is in a state where the “SKIP” option is selected, and “SKIP” is performed as any one of the operation buttons 16 is pushed.

In other words, according to the configuration of FIG. 4B, by selecting (highlighting) the “SKIP” option, it is possible to simply skip to the chronograph measurement screen which displays the waiting state of the initiation of the measurement by pushing the operation button 16 once. Next, since an elapsed time measurement can be started by pushing the operation button 16 once, it is possible to provide the electronic device and a guidance image display which are excellent in usability with respect to the user.

Furthermore, an aspect, in which a setting that displays the “CANCEL” option at a head can be changed and registered by the user, can be considered. In addition, according to the capturing circumstance of the satellite signal, an aspect, in which the “SKIP” option is displayed to be larger or smaller, can be considered.

Next, the process portion 30 determines whether or not the capturing with respect to the satellite signal of the four GPS satellites 90 is completed (Step S108). Here, when the capturing is completed (YES in Step S108), the process portion 30 completes the satellite capturing process (Step S110). In the embodiment, when the satellite signals of the four GPS satellites 90 are captured, a capture complete screen is displayed as illustrated in FIG. 4D.

Next, the process portion 30 transits to a state where the chronograph process is possible. At the same time, the control portion 36 transits to a chronograph display mode, and displays the chronograph screen on the display portion 46 as illustrated in FIG. 4E (Step S112). In this case, the movement distance measured by the GPS signal process portion 32 is initialized, and the movement distance displayed on the display portion 46 is displayed as an initial value.

Next, the process portion 30 determines whether or not a performance of a timing process by the operation from the operation portion 40 is indicated (Step S114). Here, when the performance of the timing process is indicated (YES in Step S114), the indicated timing process is performed (Step S116), and the process goes back to Step S112. Meanwhile, when the performance of the timing process is not indicated (NO in Step S114), the process goes back to Step S112.

In this manner, a state of the transition to another mode by the interrupted indication from a system, or a state where the chronograph display mode is held until the completion is indicated by pushing the operation button 16, continues.

Here, when the process goes back to the determination of Step S108 and the capturing of the satellite signal of the four GPS satellites 90 is not completed (NO in Step S108), the process portion 30 determines whether or not the operation button 16 is pushed according to the “SKIP” option and the SKIP is indicated (Step S120).

Here, when the SKIP is not indicated (NO in Step S120), the process portion 30 continues the satellite capturing process (Step S130) and goes back to Step S108.

Meanwhile, when the SKIP is indicated (YES in Step S120), the control portion 36 transits to the chronograph display mode, changes the search screen, and displays the chronograph screen (FIG. 4E) on the display portion 46 (Step S122).

Furthermore, the process portion 30 transits to a state where the chronograph process is possible, and at the same time, the satellite capturing process continues (Step S124).

Next, the process portion 30 determines whether or not the performance of the timing process by the operation from the operation portion 40 is indicated (Step S126). Here, when the performance of the timing process is indicated (YES in Step S126), the indicated timing process is performed (Step S128), and the process goes back to Step S108. Meanwhile, when the performance of the timing process is not indicated (NO in Step S126), the process goes back to Step S108.

According to the above-described embodiment, the following is effective.

(1) When the search screen which shows the capturing circumstance for every satellite while the satellite signal of the GPS satellite 90 is captured is displayed on the display portion 46, and when the transition to a state where the timing measurement is possible by the SKIP indication of the user during the capturing is indicated, the running watch 10 displays the chronograph screen on the display portion 46 in a state where the capturing of the satellite signal continues, and performs the timing process corresponding to the timing indication, in parallel. Therefore, in a case of the timing by using the running watch 10, the user can immediately perform the chronograph function without waiting for the capturing of the GPS satellite 90 to be completed.

(2) When the running watch 10 captures the satellite signal transmitted from the GPS satellite 90, since the display portion 46 displays the search screen which visually shows the capturing circumstance for every GPS satellite 90, the user can assume the remaining time which is necessary until the end of the capturing and indicate the SKIP effectively based on the assumption result.

There is a case where the apparatus which performs the above method is realized by a single apparatus, and there is a case where the apparatus is realized by combining a plurality of apparatuses. The apparatus includes various aspects.

Each configuration and the combination thereof in each embodiment is an example. The configuration can be added, omitted, changed, and modified without departing from the scope of the invention. In addition, the embodiment of the invention is not limited, and limited only to the scope of the appended claims.

The entire disclosure of Japanese Patent Application No. 2013-181107, filed Sep. 2, 2013 is expressly incorporated by reference herein.

What is claimed is:

1. An electronic device, comprising:
a reception process portion which captures a satellite signal transmitted from a positioning satellite and processes the satellite signal;
a measurement process portion which measures a lapse of time;
a display portion which displays a screen;
an indication portion which indicates an operation; and
a control portion which displays a first screen showing a capturing circumstance of the satellite signal on the display portion when the reception process portion initiates the capturing of the satellite signal, and which continues the capturing of the satellite signal with respect to the reception process portion and displays a second screen showing that a measurement can be initiated by the measurement process portion on the display portion when a predetermined operation is indicated from the indication portion.

2. The electronic device according to claim 1,
wherein at least one of an image of the positioning satellite corresponding to the capturing circumstance and a guidance image for indicating the predetermined operation by the indication portion, is displayed on the first screen.

3. The electronic device according to claim 1,
wherein, on the first screen, the image of the positioning satellite corresponding to the capturing circumstance and the guidance image for indicating the predetermined operation by the indication portion are displayed at the same time.

4. The electronic device according to claim 1,
wherein, on the second screen, at least one of temporal information which is necessary in moving based on the measurement of the measurement process portion and movement information calculated based on the satellite signal is displayed.

5. The electronic device according to claim 4, further comprising:
an acceleration detection portion which detects acceleration and calculates a movement amount based on the detected acceleration,
wherein the control portion calculates the movement information based on the movement amount calculated by the acceleration detection portion when the capturing of the satellite signal is not completed.

6. The electronic device according to claim 1,
wherein the reception process portion obtains orbital information showing a position on an orbit of the positioning satellite, and determines the positioning satellite based on the obtained orbital information.
